(19) United States
(12) Patent Application Publication
(10) Pub. No.: US 2008/0190960 A1
(43) Pub. Date: Aug. 14, 2008

(54) Manual Piston Pump Having A Blockable Dispensing Head For Dispensing Fluid Substances

(76) Inventors: Robert Pfannhauser, Dusseldorf (DE); Thomas Hohmann, Iserlohn (DE)

Correspondence Address: MEADWESTVACO CORPORATION, 1021 MAIN CAMPUS DRIVE, CENTENNIAL CAMPUS, RALEIGH, NC, 27606, US

(21) Appl. No.: 11/909,321

(22) PCT Filed: Mar. 21, 2006
(86) PCT No.: PCT/EP2006/002559

§ 371 Date: Nov. 8, 2007

(30) Foreign Application Priority Data
Mar. 23, 2005 (DE) 102005013408.4

(51) Int. Cl. B67D 5/00; B67D 5/40

(52) U.S. Cl. 222/153.13; 222/384

(57) ABSTRACT

Manual piston pump having a blockable dispensing head for dispensing fluid substances, having a cylinder, an inner locking sleeve forming a cylindrical passage for a hollow piston rod to pass through, one end of this extending into a pump chamber of the cylinder and the other end carrying the dispensing head, which is provided with an outer shaft section, a spring which presses the piston rod outwards in relation to the cylinder, into a rest position, and in opposition to the spring force whereof the piston rod may be lowered by pressing on the dispensing head in order to dispense substance, and having a means for blocking the dispensing head, this means including at least one locking element which may be brought into engagement with the locking sleeve, in which, together with the piston rod (6), the locking sleeve (5) forms an inner cage (18) for receiving the spring (19), which is supported at one end against a base (20) of the locking sleeve (5) and at the other against the locking element (21) provided on the piston rod (6), and, together with the cylinder (2) and along the length of the upper section facing the dispensing head (1), the locking sleeve (5) forms a guide channel (11) acting as a track for the outer shaft section (12) of the dispensing head (1) to move along, parallel to the piston rod (6).

### CROSS-REFERENCE TO RELATED APPLICATIONS

This application claims the benefit of German Application No. 10 2005 013 408.4, entitled “Handkolbenpumpe mit blockierbarem Ausgabekopf zur Ausgabe von fluiden Substanzen,” filed 23 Mar. 2005, and PCT Application No. PCT/EP2006/002559, entitled “Handkolbenpumpe mit blockierbarem Ausgabekopf zur Ausgabe von fluiden Substanzen,” filed 21 Mar. 2006, and incorporates herein each of these applications by reference in their entirety.

### BACKGROUND OF THE INVENTION

1. Field of the Invention

The invention relates to a manual piston pump having a blockable dispensing head for dispensing fluid substances, having a cylinder, an inner locking sleeve forming a cylindrical passage for a hollow piston rod to pass through, one end of this extending into a pump chamber of the cylinder and the other end carrying the dispensing head, which is provided with an outer shaft section, a spring which presses the piston rod outwards in relation to the cylinder, into a rest position, and in opposition to the spring force whereof the piston rod may be lowered by pressing on the dispensing head in order to dispense substance, and having a means for blocking the dispensing head, this means including at least one locking element which may be brought into engagement with the locking sleeve.

2. State of the Art

DE 33 16 308 A1 discloses a manual pump which has a dispensing head mounted on the shaft of the pump itself. In the normal rest condition, this shaft projects beyond the exterior of a hollow main part forming the base body of the pump. The lower end of a hollow movable shaft extends inside the cavity of the main part and is pressed outwards by a spring acting on its lower end. Furthermore, a locking sleeve is fixedly connected to the hollow main part. The pump has one or more cams or small teeth or projections, as a result of which the dispensing head may be locked to the locking sleeve. Moreover, the pump has one or more sealing inserts which close off in relation to the outside atmosphere when the dispensing head is locked on the base body of the pump.

The advantage of a lockable dispensing head is linked to the disadvantage that, when the dispensing head is pressed down, it is frequently skewed. When the dispensing head is skewed, the piston strokes are not performed in their entirety, with the result that these strokes are performed multiple times, which means that undesirable excessive quantities are then supplied. Furthermore, there is increased wear.

The object of the invention is therefore to provide a manual piston pump having a cylinder, an inner locking sleeve forming a cylindrical passage for a hollow piston rod to pass through, one end of this extending into a pump chamber of the cylinder and the other end carrying the dispensing head, which is provided with an outer shaft section, a spring which presses the piston rod outwards in relation to the cylinder, into a rest position, and in opposition to the spring force whereof the piston rod may be lowered by pressing on the dispensing head in order to dispense substance, and having a means for blocking the dispensing head, this means including at least one locking element which may be brought into engagement with the locking sleeve which is equipped with a locking sleeve and at the same time operates reliably and with low wear.

### BRIEF DESCRIPTION OF THE DRAWINGS

The invention will be explained in more detail below with reference to the exemplary embodiment illustrated in the attached drawings.

FIG. 1 shows, diagrammatically and in longitudinal section, a manual piston pump in the rest condition,

FIG. 2 shows, diagrammatically and in longitudinal section, the manual piston pump according to FIG. 1, with the dispensing head lowered, and

FIG. 3 shows diagrammatically a perspective side view of the locking sleeve of the manual piston pump according to FIGS. 1 and 2.

### DETAILED DESCRIPTION OF THE INVENTION

With this, a manual piston pump is provided in which the locking sleeve encapsulates the spring in order to position the spring for the purpose of low-wear spring pre-tensioning of the dispensing head and for the purpose of controlling pre-tensioning against the locking element, and furthermore this encapsulation means forms, together with the cylinder, a track for the external shaft section of the dispensing head to move along. In this case, the dispensing head is not only reliably locked but the dispensing head is also guided during piston strokes, as a result of which pressure on the dispensing head at an oblique angle is compensated. It is not possible for skewing to occur. The pre-tension acting on the locking element furthermore compensates for manufacturing tolerances, without having any adverse effect on functionality. The possibility that the fluid substance will oxidize is eliminated because the spring is arranged outside the product flow.

Preferably, the use of two projections as the locking element, which act as pins to provide a support for the spring without this having an adverse effect on its function of being capable of engaging in a recess in order to bring about locking.

The dispensing head may be locked in the top position and/or in the bottom position.

Further embodiments of the invention are apparent from the description below and from the claims.

The invention relates to a manual piston pump having a blockable dispensing head 1 for dispensing fluid substances. The manual piston pump includes a cylinder 2 whereof the upper end is fixedly connected to a closure 3, which may be secured to the mouthpiece of a container (not illustrated) for receiving a liquid or soap-type substance to be dispensed. The closure 3 is in this case provided with a thread acting as the closing element. The cylinder 2 may have a ring 4 acting as the upper termination.

An inner locking sleeve 5 is seated in a fixedly positioned manner in the cylinder 2 in such a way that a cylindrical passage is formed for a hollow piston rod 6 to pass through. The locking sleeve 5 is preferably clamped in the cylinder 2, and for this purpose the locking sleeve 5 may carry a clamping ring 7 which has a sealing lip 8 and may be supported against a shoulder 9 of the cylinder 2. The locking sleeve 5 extends along the length of an upper portion of the cylinder 2, with an upper end 10 of the locking sleeve 5 extending as far as an upper end of the cylinder 2, in this case formed by the ring 4, or being capable of projecting beyond the ring 4.

Together with the cylinder 2 and along the length of an upper section of the cylinder 2 facing the dispensing head 1, the locking sleeve 5 forms a guide channel 11 acting as a track for an outer shaft section 12 of the dispensing head 1 to move along, parallel to the piston rod 6. In addition to the outer shaft section 12, the dispensing head 1 has an inner shaft section which is spaced therefrom, by way of which it is secured to the piston rod 6 and which prolongs the dispensing channel 29 beyond the hollow piston rod 6.

By means of one end 13 the piston rod 6 extends into a pump chamber 22 of the cylinder 2, and at the other end 14 it carries the dispensing head 1 provided with the outer shaft section 12. At the one end 13 there is seated a collar 15 which seals the pump chamber 22 of the cylinder 2 off from the upper part of the cylinder 2. The end 13 has at least one inlet opening 16 for connecting the pump chamber 22 to a cavity 17 inside the hollow piston rod 6.

Together with the piston rod 6, the locking sleeve 5 forms an inner cage 18 for receiving a spring 19 which presses the piston rod 6 outwards in relation to the cylinder 2, into a rest position, and in opposition to the spring force whereof the piston rod 6 may be lowered by pressing on the dispensing head 1 in order to dispense substance. The spring 19 is supported at one end against a base 20 of the locking sleeve 5 and at the other against a locking element 21 provided on the piston rod 6.

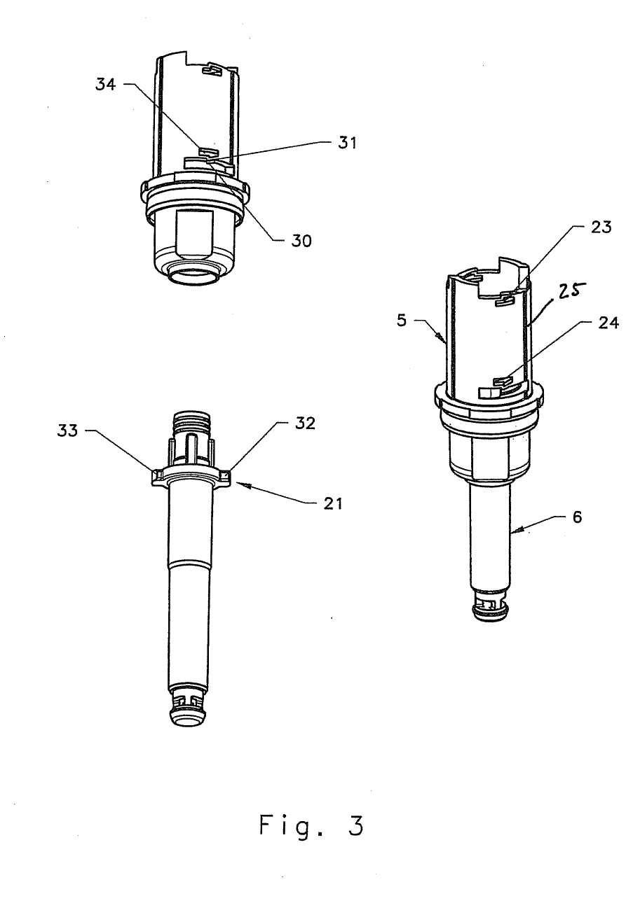

The locking element 21 is part of a means for blocking the dispensing head 1, this means including at least one locking element which may be brought into engagement with the locking sleeve 5. The locking sleeve 5 is illustrated again as an individual part in FIG. 3. So that the manual piston pump may be locked with the dispensing head 1 in the top position and/or the bottom position, the locking sleeve 5 may be formed with appropriate recesses 23, 24 in which the locking element 21 of the piston rod 6 can engage. For this purpose, the piston rod 6 preferably has as the locking element 21 two opposing cams or projections which may be brought into engagement with the recesses 23, 24 by turning the piston rod 6 in the locking sleeve 5, by turning the dispensing head 1. In a disengaged position, the locking element 21, which extends transversely in relation to the longitudinal extent of the locking sleeve 5, is guided in grooves 25 which are formed in the locking sleeve 5 and allow longitudinal movement during piston strokes.

The pump chamber 22 may preferably be closed off temporarily from a riser tube 27 by a ball 26.

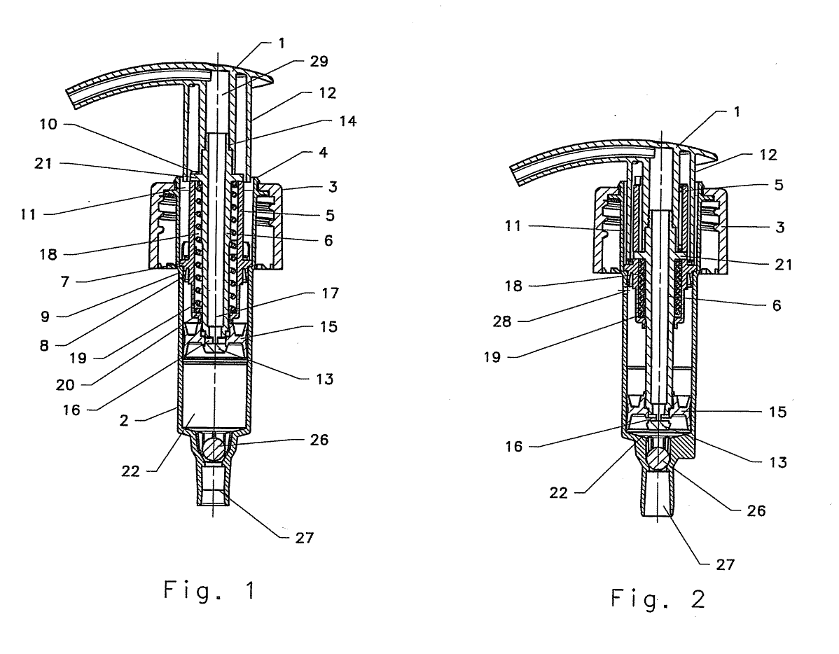

FIG. 1 illustrates the manual piston pump in the rest position. The dispensing head 1 may be locked in this top position. In the rest position, the outer shaft section 12 is preferably inserted into the guide channel 11 in order to ensure adequate guidance at the very start of each piston stroke. The clamping ring 7 of the locking sleeve 5 may form an abutment for a depth to which the outer shaft section 12 may penetrate into the guide channel 11.

FIG. 2 illustrates the manual piston pump in the lowered position. The dispensing head 1 may also be locked in this bottom position. Air may be drawn in by way of a draw-in opening 28 in the wall of the cylinder 2. Seals and/or filters for the incoming air may be provided.

1. A manual piston pump having a blockable dispensing head for dispensing fluid substances, having a cylinder, an inner locking sleeve forming a cylindrical passage for a hollow piston rod to pass through, one end of this extending into a pump chamber of the cylinder and the other end carrying the dispensing head, which is provided with an outer shaft section, a spring which presses the piston rod outwards in relation to the cylinder, into a rest position, and in opposition to the spring force whereof the piston rod may be lowered by pressing on the dispensing head in order to dispense substance, and having a means for blocking the dispensing head, this means including at least one locking element which may be brought into engagement with the locking sleeve, the improvement comprising the locking sleeve together with the piston rod forming an inner cage for receiving the spring, which spring is supported at one end against a base of the locking sleeve and at the other end against the locking element provided on the piston rod.

2. The manual piston pump of claim 1, wherein the locking element further comprises two opposing projections extending transversely in relation to the longitudinal extent of the locking sleeve.

3. The manual piston pump of claim 1, wherein the improvement further comprising the locking sleeve together with the cylinder forming a guide channel acting as a track for the outer shaft section of the dispensing head, wherein the manual piston pump in the rest position includes an initial part of the outer shaft section of the dispensing head projecting into the guide channel.

4. The manual piston pump of claim 1, wherein the locking sleeve comprises recesses which may be brought into engagement with the locking element in a top position and in a bottom position.

5. The manual piston pump of claim 3, wherein the locking sleeve is positioned in the cylinder in a fixedly seated manner by way of a clamping ring which forms an abutment for the outer shaft section in the guide channel.

6. A manual pump, comprising:
a cylinder defining a pump chamber;
an inner locking sleeve extending into at least a portion of the pump chamber of the cylinder, the inner locking sleeve defining an interior space;
a piston rod extending into at least a portion of the interior space of the inner locking sleeve; and
a spring positioned in the interior space between the piston rod and the inner locking sleeve,
wherein the interior space between the inner locking sleeve and piston rod prevents the spring from contacting a fluid being pumped by the manual pump.

7. The manual pump of claim 6, wherein the locking sleeve further comprises a clamping ring configured to clamp to the cylinder.

8. The manual pump of claim 6, wherein the piston rod further comprises a locking element.

9. The manual pump of claim 6, wherein the piston rod further comprises a hollow piston rod and at least one end of the hollow piston rod extends through the inner locking sleeve into the pump chamber.

10. The manual pump of claim 6, further comprising a dispensing head.

11. The manual pump of claim 10, wherein the dispensing head comprises an outer shaft section positioned between an inner surface of the cylinder and an outer surface of the inner locking sleeve, wherein movement of the dispensing head is guided by the cylinder and the inner locking sleeve.

12. The manual pump of claim 11, wherein the piston rod further comprises a locking element.

13. The manual pump of claim 12, wherein the locking element prevents movement of the dispensing head in a first position relative to the inner locking sleeve.

14. The manual pump of claim 12, wherein the locking element allows movement of the dispensing head in a second position relative to the inner locking sleeve.

15. The manual pump of claim 12, wherein the inner locking sleeve further comprises at least one recess configured to engage the locking element.

16. The manual pump of claim 15, wherein the at least one recess comprises at least one recess configured to engage the locking element in a top position.

17. The manual pump of claim 15, wherein the at least one recess comprises at least one recess configured to engage the locking element in a bottom position.

18. A dispenser, comprising:
a bottle; and
a manual pump connected to the bottle and configured to pump a substance from the bottle, wherein the manual pump comprises:
a cylinder defining a pump chamber;
an inner locking sleeve extending into at least a portion of the pump chamber of the cylinder, the inner locking sleeve defining an interior space;
a piston rod extending into at least a portion of the interior space of the inner locking sleeve; and
a spring positioned in the interior space between the piston rod and the inner locking sleeve, wherein the interior space between the inner locking sleeve and piston rod prevents the spring from contacting a fluid being pumped by the manual pump.

19. The dispenser of claim 18, further comprising a liquid contained in the bottle.
